(19) United States
(12) Patent Application Publication
(10) Pub. No.: US 2006/0274976 A1
(43) Pub. Date: Dec. 7, 2006

(54) Image scaling

(75) Inventor: Christian Hentschel, Cottbus (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/539,320

(22) PCT Filed: Nov. 18, 2003
(86) PCT No.: PCT/IB03/05362

§ 371 Date: Jun. 15, 2005

(30) Foreign Application Priority Data
Dec. 19, 2002 (EP) 02080380.5

(51) Int. Cl. G06K 9/32

(52) U.S. Cl. 382/300

(57) ABSTRACT

A method of converting a first image (102) with a first resolution into a second image (106) with a second resolution, comprises pixel value insertion and convolution based on a non-separable multi-dimensional kernel which comprises a plurality of coefficients being equal to zero, a first portion of the plurality of coefficients being disposed on a first diagonal line through the non-separable multi-dimensional kernel and a second portion of the plurality of coefficients being disposed on a second diagonal line through the non-separable multi-dimensional kernel, the second diagonal line being perpendicular to the first diagonal line. A diagonal edge of 45 degrees in the first image is preserved in the case of an iso-trope scaling. That means that, if pixel values on the edge in the first image are mutually equal, then also the pixel values on the edge in the second image are mutually equal. Optionally, the method comprises sub-sampling.

The invention relates to a method of converting a first image with a first resolution into a second image with a second resolution, the first resolution being different from the second resolution.

The invention further relates to an image conversion unit for converting a first image with a first resolution into a second image with a second resolution, the first resolution being different from the second resolution.

The invention further relates to an image processing apparatus, comprising:

receiving means for receiving a signal corresponding to a first image; and

such an image conversion unit converting the first image with a first resolution into a second image with a second resolution.

The invention further relates to a computer program product to be loaded by a computer arrangement, comprising instructions to convert a first image with a first resolution into a second image with a second resolution, the first resolution being different from the second resolution.

In many video and multimedia applications it is necessary to adapt the image dimensions, preserving the quality of the output images. Adapting might mean increasing or decreasing the resolution. Increasing the resolution is required e.g. in the case that a low-resolution picture has to be displayed on a high-resolution display device. If a simple up-conversion method of pixel and line repetition is applied the output image looks bad: jagged lines and block-structures can be observed. Optionally, a low-pass filter is applied as a post processing function to reduce the visibility of the jaggies and the block-structures. A disadvantage of this low-pass filtering is a blurring of image details.

An embodiment of the method of the kind described in the opening paragraph is known from patent application WO 99/56247. This patent application discloses an image interpolation method comprising insertion of pixels along horizontal and vertical directions so as to obtain a grid in which interpolated lines cross themselves in original pixels. In a second step pixels are interpolated between rows and columns by the grid so as to fill squares by the grid to obtain an interpolated image. A disadvantage of this method is that it is relatively complex.

It is an object of the invention to provide method of the kind described in the opening paragraph which is relatively easy.

This object of the invention is achieved in that the method comprises:

pixel value insertion; and

convolution based on a non-separable multi-dimensional kernel which comprises a plurality of coefficients being equal to zero, a first portion of the plurality of coefficients being disposed on a first diagonal line through the non-separable multi-dimensional kernel and a second portion of the plurality of coefficients being disposed on a second diagonal line through the non-separable multi-dimensional kernel, the second diagonal line being perpendicular to the first diagonal line.

An important aspect of the invention is the choice of the coefficients of the convolution kernel. The choice of the coefficients of the non-separable multi-dimensional kernel is related to the pixel insertion. The non-separable multi-dimensional kernel is symmetrical in both horizontal and vertical direction.

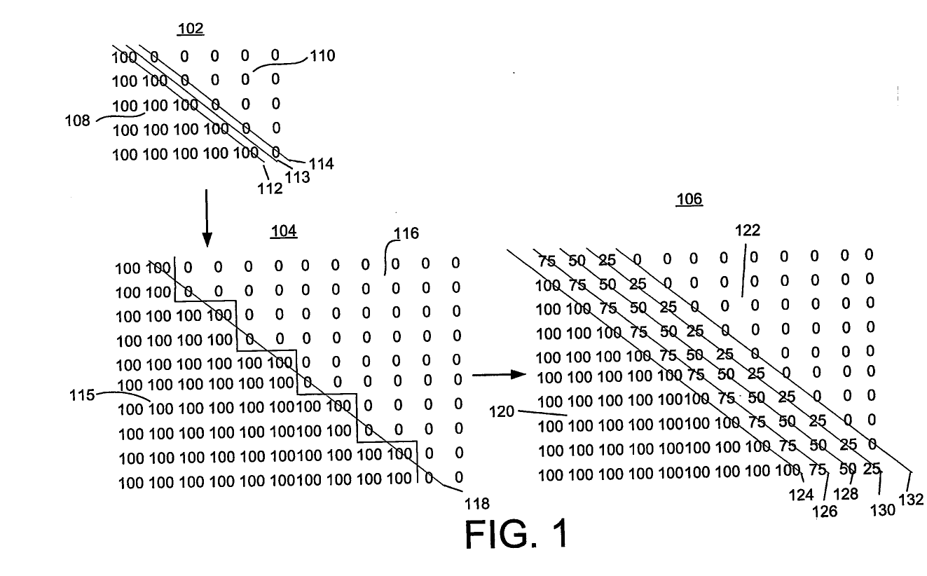

The method according to the invention is such that a diagonal edge of 45 degrees in the first image is preserved in the case of an iso-trope scaling. See also FIG. 1. Suppose that the first image comprises a first and a second region. The border between the first and second region has an angle of 45 degrees related to the rows and columns of the first image. The pixel values of the first region are mutually equal and the pixel values of the second region are mutually equal. In other words, the pixel values on the edge between first and second region are mutually equal. If this first image is converted into the second image, with an increase of horizontal and vertical resolution of a factor two, on basis of the method according to the invention then the pixel values on the edge between the first and second region in the second image are also mutually equal.

In an embodiment of the method according to the invention the pixel value insertion comprises replication of pixel values of the first image. The replication of pixel values of the first image might be in horizontal direction, in vertical direction or in both horizontal and vertical direction. The replication of pixel values might be once in one of the directions or a multiple times in one of the directions.

E.g. in the case that an increase of both horizontal and vertical resolution of a factor two is required, a pixel replication in horizontal direction per input pixel is performed and a line repetition per line of the intermediate image is performed. After that, a convolution is performed with the non-separable multi-dimensional kernel which is specified by its coefficients:

$$[ \begin{matrix}0 & c & 0 \\ c & 0 & c \\ 0 & c & 0\end{matrix} ] ,$$

with c being unequal to zero, e.g. c=1.

It will be clear that the order of pixel replication and line repetition might be different.

E.g. in the case that an increase of both horizontal and vertical resolution of a factor three is required, two times a pixel replication in horizontal direction per input pixel and two times a line repetition per line of the intermediate image are performed. After that, a convolution is performed with the non-separable multi-dimensional kernel which is specified by its coefficients:

$$[ \begin{matrix}0 & 0 & c & 0 & 0 \\ 0 & c & 0 & c & 0 \\ c & 0 & c & 0 & c \\ 0 & c & 0 & c & 0 \\ 0 & 0 & c & 0 & 0\end{matrix} ] ,$$

with c being unequal to zero, e.g. c=1.

In another embodiment of the method according to the invention, the pixel value insertion comprises insertion of pixels with values equal to zero and the convolution is performed with a second kernel which is based on a further convolution of the non-separable multi-dimensional kernel with a third kernel. E.g. in the case that an increase of both horizontal and vertical resolution of a factor two is required, for each of the input pixels three pixel values being equal to zero are inserted. After that, a convolution is performed with the second kernel which is specified by its coefficients:

$$[ \begin{matrix}0 & d & d & 0 \\ d & e & e & d \\ d & e & e & d \\ 0 & d & d & 0\end{matrix} ] ,$$

with e=2d, e.g. d=1 and e=2.

It will be clear that the result of this embodiment according to the invention is equal to the result of the embodiment which comprises pixel replication.

Another embodiment of the method according to the invention comprises sub-sampling. With this embodiment a scaling can be achieved with a non-integer factor, e.g. 1.5 or 0.25 or 0.66.

It is a further object of the invention to provide an image conversion unit of the kind described in the opening paragraph which is relatively easy.

This object of the invention is achieved in that the image conversion unit comprises:

a pixel value insertion unit for insertion of pixel values; and

a convolution unit for a convolution based on a non-separable multi-dimensional kernel which comprises a plurality of coefficients being equal to zero, a first portion of the plurality of coefficients being disposed on a first diagonal line through the non-separable multi-dimensional kernel and a second portion of the plurality of coefficients being disposed on a second diagonal line through the non-separable multi-dimensional kernel, the second diagonal line being perpendicular to the first diagonal line.

It is a further object of the invention to provide an image processing apparatus comprising an image conversion unit of the kind described in the opening paragraph which is relatively easy.

This object of the invention is achieved in that the image conversion unit comprises:

a pixel value insertion unit for insertion of pixel values; and

a convolution unit for a convolution based on a non-separable multi-dimensional kernel which comprises a plurality of coefficients being equal to zero, a first portion of the plurality of coefficients being disposed on a first diagonal line through the non-separable multi-dimensional kernel and a second portion of the plurality of coefficients being disposed on a second diagonal line through the non-separable multi-dimensional kernel, the second diagonal line being perpendicular to the first diagonal line.

The image processing apparatus optionally comprises a display device for displaying the second image. The image processing apparatus might e.g. be a TV, a set top box, a VCR (Video Cassette Recorder) player, a satellite tuner, a DVD (Digital Versatile Disk) player or recorder.

It is a further object of the invention to provide a computer program product of the kind described in the opening paragraph which is relatively easy.

This object of the invention is achieved in that the computer program product, after being loaded, providing said processing means with the capability to carry out:

pixel value insertion; and

convolution based on a non-separable multi-dimensional kernel which comprises a plurality of coefficients being equal to zero, a first portion of the plurality of coefficients being disposed on a first diagonal line through the non-separable multi-dimensional kernel and a second portion of the plurality of coefficients being disposed on a second diagonal line through the non-separable multi-dimensional kernel, the second diagonal line being perpendicular to the first diagonal line.

Modifications of method and variations thereof may correspond to modifications and variations thereof of the image conversion unit described.

These and other aspects of the method, the image conversion unit, the image apparatus and of the computer program product according to the invention will become apparent from and will be elucidated with respect to the implementations and embodiments described hereinafter and with reference to the accompanying drawings, wherein:

FIG. 1 schematically shows a first embodiment of the method according to the invention for an increase in horizontal and vertical resolution with a factor of two;

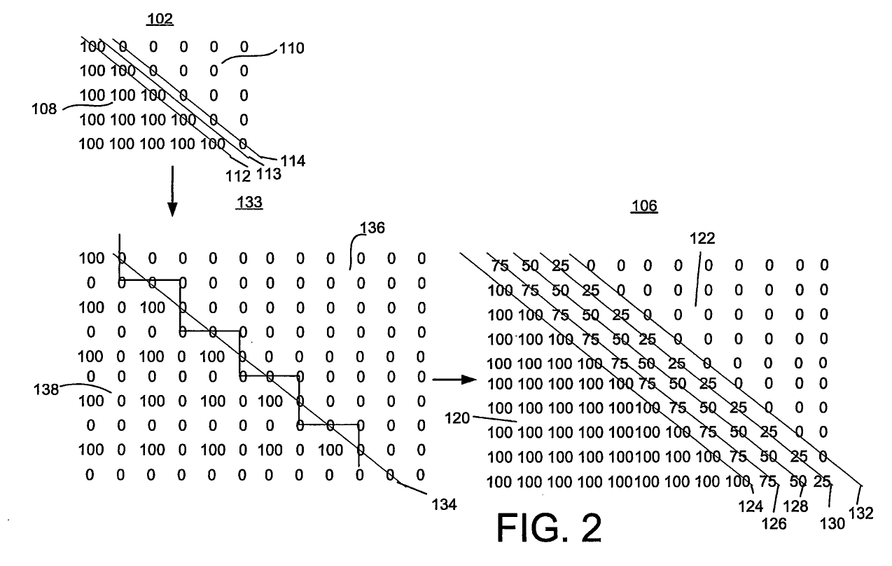

FIG. 2 schematically shows a second embodiment of the method according to the invention for an increase in horizontal and vertical resolution with a factor of two;

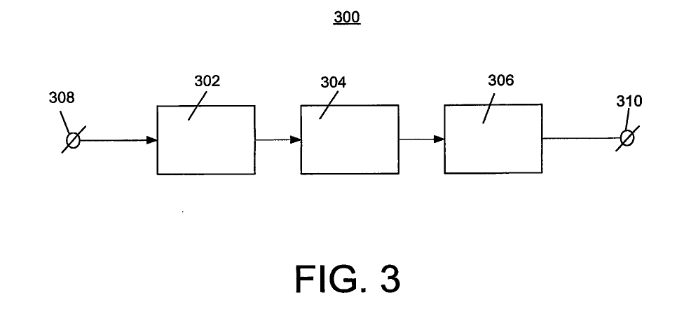

FIG. 3 schematically shows an embodiment of the image conversion unit according to the invention;

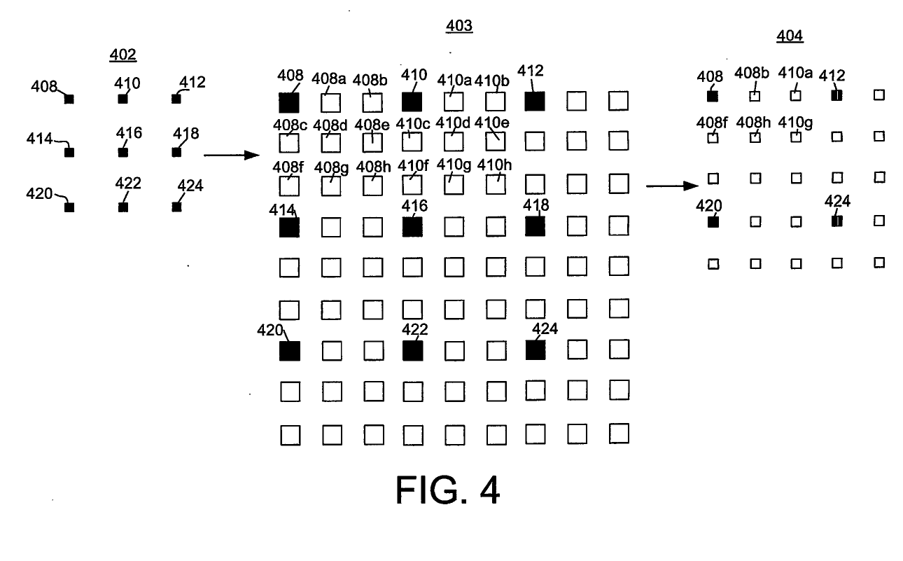

FIG. 4 schematically shows the method according to the invention for an increase in horizontal and vertical resolution with a factor of one-and-a-half; and

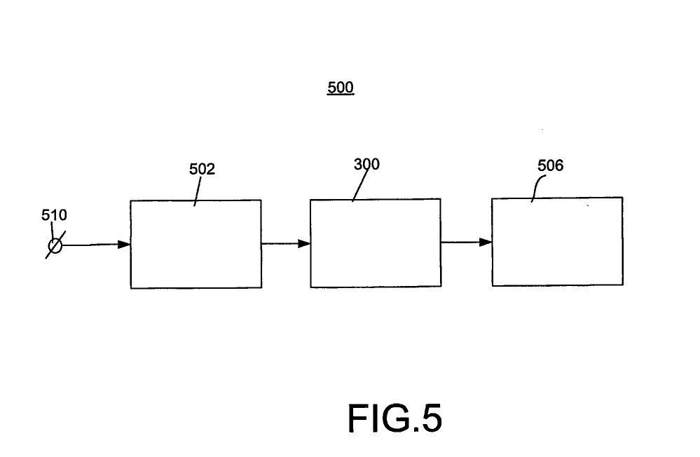

FIG. 5 schematically shows an embodiment of the image processing apparatus according to the invention.

Same reference numerals are used to denote similar parts throughout the figures.

FIG. 1 schematically shows a first embodiment of the method according to the invention for an increase in horizontal and vertical resolution with a factor of two. The method according to the invention is such that a diagonal edge 113 of 45 degrees in an input image 102 is preserved. The input image comprises a first 108 and a second region 110. When assuming squared pixels, then the border between the first 108 and second region 110 has an angle of 45 degrees related to the rows and columns of the first image. The pixel values of the first region are mutually equal. Their value is 100. The pixel values of the second region 110 are also mutually equal. Their value is 0. In other words, the pixel values along the edge 112 between first 108 and second region 110 are mutually equal, i.e. these values are all 100; and the pixel values along the edge 114 between first 108 and second region 110 are mutually equal, i.e. these values are all 0. The conversion comprises two steps.

First the input image 102 is extended by means of a sample-and-hold filter, as specified in Equation 1:

$${R}_{( 2 , 2 )} = [ \begin{matrix}1 & 1 \\ 1 & 1\end{matrix} ] \qquad ( 1 )$$

with R_{(2,2)} the sample-and-hold filter which is arranged to increase both the horizontal and vertical resolution by a factor two, by means of replication and repetition. The resulting intermediate image 104 comprises block-structures. The pixel values on the edge 118 between the first and second region 116 in the intermediate image 104 are not mutually equal. These values are alternatingly 100 and 0.

Second the intermediate image 104 is convoluted with a non-separable multi-dimensional kernel K₂^{R} as specified in Equation 2:

$${K}_{2}^{R} = \frac{1}{4} [ \begin{matrix}0 & 1 & 0 \\ 1 & 0 & 1 \\ 0 & 1 & 0\end{matrix} ] \qquad ( 2 )$$

This non-separable multi-dimensional kernel K₂^{R} has a checker-board pattern of coefficients being equal to zero and coefficients being unequal to zero. It can be seen that the non-separable multi-dimensional kernel K₂^{R} comprises the same coefficients of the sample-and-hold filter I_{(2,2)} but rotated over 45 degrees.

The pixel values on the edge 128 between the first 120 and second region 122 in the output image 106 are mutually equal: 50. Also the pixel values on the respective lines 124-126 and 130-132, all being parallel to the edge 128 are mutually equal: 100, 75, 25 and 0, respectively.

FIG. 2 schematically shows a second embodiment of the method according to the invention for an increase in horizontal and vertical resolution with a factor of two. Again the conversion comprises two steps.

First the input image 102 is extended by means of insertion of pixels with value 0, as specified in Equation 3:
I_{(2,2)}=[1] (3)
with I_{(2,2)} the insertion operation. The resulting intermediate image 133 comprises block-structures. The pixel values in region 138 are not mutually equal. These values are alternatingly 100 and 0.

Second, the intermediate image 133 is convoluted with kernel K₂^{I} as specified in Equation 4:

$${K}_{2}^{I} = \frac{1}{4} [ \begin{matrix}0 & 1 & 1 & 0 \\ 1 & 2 & 2 & 1 \\ 1 & 2 & 2 & 1 \\ 0 & 1 & 1 & 0\end{matrix} ] \qquad ( 4 )$$

The pixel values on the edge 128 between the first 120 and second region 122 in the output image 106 are mutually equal: 50. Also the pixel values on the respective lines 124-126 and 130-132, all being parallel to the edge 128 are mutually equal: 100, 75, 25 and 0.

The method as illustrated in connection with FIG. 1 and the method illustrated in connection with FIG. 2 provide the same result. This is also demonstrated with Equations 5 and 6:

$$\begin{matrix}[ \begin{matrix}1 & 1 \\ 1 & 1\end{matrix} ] * \frac{1}{4} [ \begin{matrix}0 & 1 & 0 \\ 1 & 0 & 1 \\ 0 & 1 & 0\end{matrix} ] = [ 1 ] * \frac{1}{4} [ \begin{matrix}0 & 1 & 1 & 0 \\ 1 & 2 & 2 & 1 \\ 1 & 2 & 2 & 1 \\ 0 & 1 & 1 & 0\end{matrix} ] & ( 5 ) \\ {R}_{( 2 , 2 )} * {K}_{2}^{R} = {I}_{( 2 , 2 )} * {K}_{2}^{I} & ( 6 )\end{matrix}$$

It will be clear that the same is true for other scaling factors.

FIG. 3 schematically shows an embodiment of the image conversion unit 300 according to the invention, comprising:

a pixel insertion unit 302 which is arranged to extent an input image, i.e. a pixel matrix, by means of insertion of pixel values. The result of the extension is an intermediate image. The inserted pixel values can be based on the pixel values of the pixel matrix as described in connection with FIG. 1. In that case the pixel insertion unit 302 is a sample-and-hold filter. Alternatively the inserted pixel value are equal to zero, as described in connection with FIG. 2. Alternatively, the pixel insertion unit 302 is arranged to insert a first number of pixel values per original pixel of the input image in horizontal direction and a second number of pixel values per original pixel of the input image in vertical direction, with the second number being different from the first number. That means that optionally the extension in horizontal direction and vertical direction are different, e.g. a factor of two in horizontal direction and a factor of four in vertical direction. It is also possible that the extension is only in one of the two directions. E.g. by extension in vertical direction only, a simple type of de-interlacing can be achieved. In case of pure decimation, the pixel insertion unit 302 may be obsolete and skipped.

a convolution filter 304 for convolution of the extended intermediate image, based on a non-separable multi-dimensional kernel which comprises a plurality of coefficients being equal to zero, a first portion of the plurality of coefficients being disposed on a first diagonal line through the non-separable multi-dimensional kernel and a second portion of the plurality of coefficients being disposed on a second diagonal line through the non-separable multi-dimensional kernel, the second diagonal line being perpendicular to the first diagonal line. The convolution is e.g. as specified in Equation 2 or Equation 4.

a sub-sampling unit 306 for selecting a part of the pixels of the output of the convolution filter 304. This sub-sampling unit 306 is optional. The sub-sampling unit 306 is arranged to select equidistantly disposed pixels, e.g. every second pixel to sub-sample with a factor of two or every third pixel to sub-sample with a factor of three.

The image conversion unit 300 is provided with an input image at the input connector 308 and provides an output image at the output connector 310.

The pixel insertion unit 302, the convolution filter 304 and the sub-sampling unit 306 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

The resolution of the input image can be lower than the resolution of the output image. In that case, the scaling factor is higher than one. The resolution of the input image can also be higher than the resolution of the output image. In that case, the scaling factor is lower than one. The resolution comprises a vertical component and a horizontal component. As said, the adaptation of the vertical component might be different from the adaptation of the horizontal component.

As explained above, the pixel insertion unit 302, the convolution filter 304 and the sub-sampling unit 306 are not fixed but are controllable. However the parameters of the pixel insertion unit 302, the convolution filter 304 and the sub-sampling unit 306 are mutually dependent. That means e.g. that the number of inserted pixels is related to the applied non-separable multi-dimensional kernel. The number of selected pixels is also related to the convolution with the non-separable multi-dimensional kernel.

Below some examples are given of convolution kernels to illustrate the relation with the number of inserted pixels, i.e. the up-scaling factor.

For a scaling with a factor of two, the non-separable multi-dimensional kernel K₂^{R} is specified in Equation 2.

Alternatively, the applied non-separable multi-dimensional kernel K₂^{R} is as specified in Equation 7:

$${K}_{2}^{R} = \frac{1}{6} [ \begin{matrix}1 & 0 & 1 \\ 0 & 2 & 0 \\ 1 & 0 & 1\end{matrix} ] \qquad ( 7 )$$

For a scaling with a factor of three, the sample-and-hold filter is specified in Equation 8:

$${R}_{3}^{3} = [ \begin{matrix}1 & 1 & 1 \\ 1 & 1 & 1 \\ 1 & 1 & 1\end{matrix} ] \qquad ( 8 )$$

and the non-separable multi-dimensional kernel K₃^{R} is specified in Equation 9:

$${K}_{3}^{R} = \frac{1}{9} [ \begin{matrix}0 & 0 & 1 & 0 & 0 \\ 0 & 1 & 0 & 1 & 0 \\ 1 & 0 & 1 & 0 & 1 \\ 0 & 1 & 0 & 1 & 0 \\ 0 & 0 & 1 & 0 & 0\end{matrix} ] \qquad ( 9 )$$

Alternatively, while combining the pixel insertion unit 302 and the convolution filter unit 304, the (intermediate) image is convoluted with kernel K₃^{I} as specified in Equation 10:

$${K}_{3}^{I} = \frac{1}{9} [ \begin{matrix}0 & 0 & 1 & 1 & 1 & 0 & 0 \\ 0 & 1 & 2 & 3 & 2 & 1 & 0 \\ 1 & 2 & 4 & 4 & 4 & 2 & 1 \\ 1 & 3 & 4 & 5 & 4 & 3 & 1 \\ 1 & 2 & 4 & 4 & 4 & 2 & 1 \\ 0 & 1 & 2 & 3 & 2 & 1 & 0 \\ 0 & 0 & 1 & 1 & 1 & 0 & 0\end{matrix} ] \qquad ( 10 )$$

For a scaling with a factor of four, the applied non-separable multi-dimensional kernel K₄^{R} is as specified in Equation 11:

$${K}_{4}^{R} = \frac{1}{16} [ \begin{matrix}0 & 0 & 0 & 1 & 0 & 0 & 0 \\ 0 & 0 & 1 & 0 & 1 & 0 & 0 \\ 0 & 1 & 0 & 1 & 0 & 1 & 0 \\ 1 & 0 & 1 & 0 & 1 & 0 & 1 \\ 0 & 1 & 0 & 1 & 0 & 1 & 0 \\ 0 & 0 & 1 & 0 & 1 & 0 & 0 \\ 0 & 0 & 0 & 1 & 0 & 0 & 0\end{matrix} ] \qquad ( 11 )$$

The number of selected pixels in order to sub-sample, is also related to the convolution with the non-separable multi-dimensional kernel. In Table 1 some examples are given of applied convolution kernels to illustrate the relation with the number of selected pixels, i.e. the sub-sampling factor N. In the first column the values of the up-scaling factor M are listed. The applied convolution kernels Kᵢ are listed in the second column. In the third column the values of the sub-sampling factor N are listed. In the fourth column the values of the resulting scaling factor

$$\frac{M}{N}$$

are listed.

TABLE 1
Choice of convolution kernel

| Up-scaling factor M | Applied kernel Kᵢ | Sub-sampling factor N | $\begin{matrix}Resulting scaling \\ factor \frac{M}{N}\end{matrix}$ |
|---|---|---|---|
| 3 | ${R}_{3}^{3} * {K}_{3}^{R} , or {K}_{3}^{I}$ | 2 | 3/2 |
| 1 | ${K}_{4}^{R}$ | 4 | ¼ |
| 2 | ${R}_{2}^{2} * {K}_{3}^{R} , or {K}_{3}^{I}$ | 3 | ⅔ |

As can be seen in Table 1, the applied kernel Kᵢ depends both on the up-scaling factor M and on the sub-sampling factor N. This relation is specified in Equation 12:
Kᵢ=max{M, N} (12)

FIG. 4 schematically shows the method according to the invention for an increase in horizontal and vertical resolution with a factor of one-and-a-half. Input image 402 comprises a number of pixels 408-424. By means of insertion of pixel values image 403 is achieved. In this case, the values of the pixels 408a-408h are equal to the value of pixel 408 and the values of the pixels 410a-410h are equal to the value of pixel 410. After convolution, a sub-sampling is performed resulting in the output image 404. As can be seen, the output image 404 is based on selecting a portion of the pixels. That means that a number of pixels of the convoluted image is skipped.

FIG. 5 schematically shows an embodiment of the image processing apparatus 500 according to the invention, comprising:

Receiving means 502 for receiving a signal representing input images. The signal may be a broadcast signal received via an antenna or cable but may also be a signal from a storage device like a VCR (Video Cassette Recorder) or Digital Versatile Disk (DVD). The signal is provided at the input connector 510;

The image conversion unit 300 as described in connection with FIG. 3. The image conversion 300 might be arranged to scale input images to output images. Alternatively, the image conversion unit 300 is arranged to de-interlace images, by means of vertical repetition; and

A display device 506 for displaying the output images of the image processing unit 504. This display device 506 is optional.

The image processing apparatus 500 might e.g. be a TV. Alternatively the image processing apparatus 500 does not comprise the optional display device 506 but provides the output images to an apparatus that does comprise a display device 506. Then the image processing apparatus 500 might be e.g. a set top box, a satellite-tuner, a VCR player, a DVD player or a DVD recorder. Optionally the image processing apparatus 500 comprises storage means, like a hard-disk or means for storage on removable media, e.g. optical disks. The image processing apparatus 500 might also be a system being applied by a film-studio or broadcaster.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. A method of converting a first image with a first resolution into a second image with a second resolution, the first resolution being different from the second resolution, the method comprising:
pixel value insertion; and
convolution based on a non-separable multi-dimensional kernel which comprises a plurality of coefficients being equal to zero, a first portion of the plurality of coefficients being disposed on a first diagonal line through the non-separable multi-dimensional kernel and a second portion of the plurality of coefficients being disposed on a second diagonal line through the non-separable multi-dimensional kernel, the second diagonal line being perpendicular to the first diagonal line.

2. A method as claimed in claim 1, whereby the pixel value insertion comprises replication of pixel values of the first image.

3. A method as claimed in claim 1, whereby the pixel value insertion comprises insertion of pixels with values equal to zero and the convolution is performed with a second kernel which is based on a further convolution of the non-separable multi-dimensional kernel with a third kernel.

4. A method as claimed in claim 2, whereby the non-separable multi-dimensional kernel comprises the plurality of coefficients being equal to zero and a plurality of coefficients being unequal to zero, which are disposed as:
$$[ \begin{matrix}0 & c & 0 \\ c & 0 & c \\ 0 & c & 0\end{matrix} ] ,$$
with c being unequal to zero.

5. A method as claimed in claim 2, whereby the non-separable multi-dimensional kernel comprises the plurality of coefficients being equal to zero and a plurality of coefficients being unequal to zero, which are disposed as:
$$[ \begin{matrix}0 & 0 & c & 0 & 0 \\ 0 & c & 0 & c & 0 \\ c & 0 & c & 0 & c \\ 0 & c & 0 & c & 0 \\ 0 & 0 & c & 0 & 0\end{matrix} ] ,$$
with c being unequal to zero.

6. A method as claimed in claim 2, whereby the non-separable multi-dimensional kernel comprises the plurality of coefficients being equal to zero and a plurality of coefficients being unequal to zero, which are disposed as:
$$[ \begin{matrix}0 & 0 & 0 & c & 0 & 0 & 0 \\ 0 & 0 & c & 0 & c & 0 & 0 \\ 0 & c & 0 & c & 0 & c & 0 \\ c & 0 & c & 0 & c & 0 & c \\ 0 & c & 0 & c & 0 & c & 0 \\ 0 & 0 & c & 0 & c & 0 & 0 \\ 0 & 0 & 0 & c & 0 & 0 & 0\end{matrix} ] ,$$
with c being unequal to zero.

7. A method as claimed in claim 3, whereby further coefficients of the second kernel are disposed as:
$$[ \begin{matrix}0 & d & d & 0 \\ d & e & e & d \\ d & e & e & d \\ 0 & d & d & 0\end{matrix} ] ,$$
with e=2d

8. A method as claimed in claim 1, further comprising sub-sampling.

9. An image conversion unit for converting a first image with a first resolution into a second image with a second resolution, the first resolution being different from the second resolution, the image conversion unit comprising:
a pixel value insertion unit for insertion of pixel values; and
a convolution unit for a convolution based on a non-separable multi-dimensional kernel which comprises a plurality of coefficients being equal to zero, a first portion of the plurality of coefficients being disposed on a first diagonal line through the non-separable multi-dimensional kernel and a second portion of the plurality of coefficients being disposed on a second diagonal line through the non-separable multi-dimensional kernel, the second diagonal line being perpendicular to the first diagonal line.

10. An image processing apparatus, comprising:
receiving means for receiving a signal corresponding to a first image; and
an image conversion unit converting the first image with a first resolution into a second image with a second resolution, as claimed in claim 1.

11. An image processing apparatus as claimed in claim 10, characterized in further comprising a display device for displaying the second image.

12. An image processing apparatus as claimed in claim 14, characterized in that it is a TV.

13. A computer program product to be loaded by a computer arrangement, comprising instructions to convert a first image with a first resolution into a second image with a second resolution, the first resolution being different from the second resolution, the computer arrangement comprising processing means and a memory, the computer program product, after being loaded, providing said processing means with the capability to carry out:
pixel value insertion; and
convolution based on a non-separable multi-dimensional kernel which comprises a plurality of coefficients being equal to zero, a first portion of the plurality of coefficients being disposed on a first diagonal line through the non-separable multi-dimensional kernel and a second portion of the plurality of coefficients being disposed on a second diagonal line through the non-separable multi-dimensional kernel, the second diagonal line being perpendicular to the first diagonal line.
